(19) United States
(12) Patent Application Publication
(10) Pub. No.: US 2021/0236248 A1
(43) Pub. Date: Aug. 5, 2021

(54) DENTAL RESTORATION, METHOD OF PRODUCING IT, COMPUTER PROGRAM AND METHOD OF RESTORING A TOOTH

(71) Applicant: VALOC AG, Rheinfelden (CH)

(72) Inventors: Felix FISCHLER, Hagenthal le Haut (FR); Titus FISCHLER, Zeiningen (CH)

(21) Appl. No.: 17/049,216

(22) PCT Filed: Apr. 18, 2019
(86) PCT No.: PCT/EP2019/060171

§ 371 Date: Oct. 20, 2020

(30) Foreign Application Priority Data
Apr. 20, 2018 (CH) 00507/18

(51) Int. Cl. A61C 8/00; A61C 13/00

(52) U.S. Cl. CPC A61C 8/0077; A61C 13/0019; A61C 13/0004; A61C 8/008

(57) ABSTRACT

A computer implemented method of producing a dental restoration is disclosed that includes obtaining data of an outer shape of a gingiva former, obtaining scan data of the gingiva former mounted to the implant structure, determining the orientation of the gingiva former relative to a jaw, and creating the restoration with an emergence profile formed in correspondence with the outer shape of the gingiva former and the determined orientation of the gingiva former. A dental restoration is also disclosed that includes an occlusal end, an apical end opposite to the occlusal end, an emergence profile extending from the apical end towards the occlusal end and a channel extending from the apical end to the occlusal end. A computer program is disclosed that includes computer readable commands causing a computing device to implement the method noted above, and a correlated method of restoring a tooth with a dental restoration.

### TECHNICAL FIELD

The present invention relates to a method of producing a dental restoration and more particularly to a method of CAD designing, and subsequently fabricating accordingly, a dental restoration which optimally incorporates an emergence profile, or contour, consistent with the underlying anatomic morphology of a socket in the location where a tooth or teeth needs to be replaced. The present invention also relates to a dental restoration having an emergence profile optimally complying to the soft tissue anatomy around a cavity of gingival tissue formed as a result of the removal of a tooth and to a method of restoring a missing tooth with such a dental restoration.

Such production method can be used for producing any kind of implant-retained dental restoration, such as an abutment, a crown or a bridge, in a way that the customized shape thereof best fits, fills and supports the walls of the gap or socket cavity left by the missing tooth in the adjacent soft gingival tissue. The methods according to the present invention are therefore conceived to enable aesthetic dental restorative solutions which can be patient-specific and, particularly, allow the gingival tissue in the area of the restoration to retain a natural, healthy emergence profile, possibly analogous to that taken when the original tooth was in place. The methods according to the present invention are compatible with fully digital work-flows and may be fully or partially computer implemented.

### BACKGROUND ART

Today, implant-supported dental prostheses often are the treatment of choice when a patient needs to have one tooth or a multiplicity of teeth substituted in a way that the outcome is a natural-feeling, stable restoration, especially if certain clinical conditions, such as healthy underlying bone and soft tissue structures, are met.

Dental implants normally take the form of threaded elements which are engineered to be placed into the jaw of a patient. Implant placement typically requires the opening of gingiva flaps in order to better access the implantation area. Irrespective of whether a submucosal approach or a transmucosal approach is followed, that is of whether a double-staged surgical intervention or a single-stage flap-opening is performed on the soft tissue of the gingiva, a so called healing cap or healing abutment, also more generally designatable as gingiva former, is often affixed to the inserted implant. The function of the healing cap or abutment is to preserve and retain in place the gingival tissue in the implantation site, i.e., in the area around the socket of the missing tooth, thereby preserving the anatomic emergence profile.

The temporary use of healing caps or abutments is thus intended to create the wished shape of emergence profile deemed suitable for the given patient situation. Such shaping of the gingiva is also summarized, in the technical filed of implantology, as soft tissue conditioning.

Several techniques are then employed in the state of the art to somehow transfer those pieces of information relating to the implantation site which are required for the design and production of a compatible restoration to be supported by the implant.

Conventionally, transfer impression materials are used to capture and transfer—with the aid of tools such as trays, gingiva masks, impression copings and implant analogues—the information relating to the overall positioning of the implant in the actual oral cavity to a cast model. At the end of the transfer procedure, an implant analogue embedded in the cast model replicates the overall spatial orientation of the inserted implant, including i) the angular position of the implant, and consequently of its anti-rotational features intended to hold a supported restoration in a definite, indexed position relative to the implant, ii) the axis of the implant and iii) its height with respect to soft tissue, to adjacent teeth and to the occlusal surfaces of the antagonist teeth. Thus, a suitable dental restoration can be fitted and modified in the impression cast model by a laboratory technician, on the implant analogue and/or on an intermediate abutment placed on the implant analogue.

The above transfer procedure is comparably complex and, for acceptable results, requires advanced manual dexterity from a dental laboratory technician or dentist. Also, it is required that the healing abutments are removed before an impression can be taken. Such removal bears the risk of injuries and the like.

Moreover, it is difficult to ensure by such a lengthy, multi-stepped and essentially manual process that the restoration designed on the cast model will possess—as it is desirable—substantially the same emergence profile as the emergence profile created by the healing abutment during its temporary placement onto the inserted implant for soft tissue conditioning. Given the high number of accessories and tools employed, the common transfer procedure is also very liable to time-consuming errors.

At any rate, standard healing abutments currently in use are provided in a limited array and their shapes do not render the natural forms of a tooth. Moreover, standard healing abutments do not manage to carry out a good soft tissue conditioning in situations which are not ordinary, for instance they cannot compensate for eccentrically placed implants.

In order to overcome the excessively structured and mistake-prone manual transfer process, intra-oral scanning technologies have been developed allowing to capture the essential implant orientation information directly in the oral cavity of a patient having received the implant.

However, even if intra-oral scanning per se would grant a speedier acquisition of the essential implant orientation information for production of a dental restoration to be supported by the same implant, generally scanning of the oral cavity in the site of implantation for these purposes is first successfully attempted when the so-called temporization for the purpose of soft tissue conditioning has past and the healing abutment affixed to the underlying implant can be removed without impacting a correct shaping of the emergence profile and/or causing an injury of the soft tissue.

Therefore, there is a need for a method of producing a dental restoration, and a corresponding method of restoring a tooth by a dental restoration so designed, which allows to aptly and promptly integrate in the final dental restoration the emergence profile created in the gingiva soft tissue by temporary application of a dedicated healing abutment, so that the final restoration is created with an emergence profile matching that of the healing abutment, or gingiva former, best fitting the missing tooth socket.

### DISCLOSURE OF THE INVENTION

According to the invention this need is settled by a method of producing a dental restoration as it is defined by the features of independent claim 1, by a computer program, by a dental restoration as it defined by the features of independent claim 21, as well as by a method of restoring a tooth with a dental restoration as it is defined by the features of independent claim 31. Preferred embodiments are subject of the dependent claims.

In the context of the present invention, the term “gingiva former” can relate to an element or structure designed to be arranged onto the implant structure during healing, after insertion of the implant structure, for the purpose of soft tissue conditioning. It can be shaped to reflect the form of the gingiva channel through which the implant structure is inserted after surgical opening of a flap. A healing cap or a healing abutment or a similar element can therefore more generally be types of gingiva formers.

The implant structure can comprise one or more implants in the more literal sense being a post-like element inserted as artificial root into the jaw bone. It can also comprise an abutment or base affixed to the implant or fixed to at least one remainder of an original tooth. For instance, the implant structure can comprise an intermediate base abutment, e.g. in titanium, which is designed to be placed into an implant to provide support for dental restorations, or prosthetic reconstructions, such as crowns or bridges.

The term “dental restoration” in connection with the invention relates to a structure that comprises a visible portion extending into the oral cavity as one or plural artificial teeth. The term covers crowns, bridges and the like, as well as also similar restorations. The restoration typically is individually formed in consideration of the situation give in the oral cavity where it will be placed. Thus, the restoration in accordance with the invention can be a patient specific individual restoration.

The term “relative to the jaw” as used herein can relate to an orientation to the jaw in order to have a proper position and form inside the oral cavity. The jaw is thereby understood as comprising the jaw bone, the associated soft tissue as well as the teeth together with the roots. The orientation relative to the jaw can be determined with reference to neighbouring teeth, to the jaw bone, or, particularly in cases where no teeth are available, to the soft tissue structure. The orientation relative to the jaw can also encompass spatial information relative to the occlusal surfaces opposing to the site of implant placement and of dental restoration placement. In this context, indexing can relate to the process of recording the position of implants relative to adjacent teeth and the antagonist teeth at the time of implant surgery. The ultimate purpose of indexing is to register the position of the implant in a way that a laboratory technician or a computer aided design (CAD) operator can generate correctly oriented models for the fabrication of abutments and/or crowns to be supported by the same implant. Dental restorations such as abutments and/or crowns typically comprise anti-rotational features, such as protrusions, shaped to match respective anti-rotational features, such as notches, of the implants by which they are to be retained, so that the relative spatial relationship remains locked.

The emergence profile of the dental restoration can particularly be a portion of the restoration to be positioned adjacent to, or surrounded by, the gingiva. Thus, the emergence profile can form or comprise a gingiva portion of the restoration.

In one aspect, the invention is a method of producing a dental restoration, i.e. a production method, comprising a step of obtaining an outer shape of a gingiva former, wherein the outer shape of the gingiva former suits to a gingiva channel extending from an oral cavity of the patient to an implant structure fixed to a jaw bone of a patient. The expression “gingiva channel” hereby relates to a channel surgically created by opening a flap in the gingiva, through which the implant structure is inserted.

Obtaining the outer shape can involve for example receiving data, such as digital signal(s) or the like, describing or defining the outer shape of the gingiva former. Obtaining the outer shape can be obtaining outer shape data. Obtaining such data can be provided by transferring the data from another system such as an imaging arrangement, or by identifying a specific outer shape in a digital library, or measuring the shape by appropriate means.

Additionally or alternatively, obtaining the outer shape can involve the creation of an analogue impression. Also, a forming by means of model using the analogue impression can be involved. Such analogue techniques may result in an accurate and reliable gathering of details about the outer shape based on widespread and accepted procedures.

Further, the method according to the present invention comprises a step of obtaining position of the gingiva former mounted to the implant structure and determining the orientation of the gingiva former relative to the jaw based on the position. Thereby, obtaining the position can involve scanning the gingiva former directly or via another structure. Or, it can be provided by receiving data from a remote scanning device.

The term “data” as used herein can particularly relate to digital data. Such digital data can be stored and processed in a computing device. Particularly, such data can conform to a specific format such that they can be processed by the computing device. The digital data can further be transferred as electric or other data signals or the like.

The term “computing device” as used herein can relate to a single unit or distributed arrangement of units required for processing digital data. It can comprise, e.g., a central processing unit (CPU), a random access memory (RAM), a read only memory (ROM), a data storage such as a hard disk or the like and additional elements. It can be equipped with various interfaces, e.g., for interacting with a human being such as via a monitor, a keyboard or a computer mouse, communication adapters such as wireless or wired network adapters and the like. For example, the computing device can be a personal computer, a server computer, a laptop computer, a tablet, a smartphone, a distributed computing system or the like.

Following the above preparatory steps, the method comprises the step of creating the restoration having an emergence profile which is formed in correspondence with the obtained outer shape of the gingiva former and the determined orientation of the gingiva former.

In this context, the term “in correspondence with” includes the creation of an identical shape such that that the emergence profile of the restoration has the same form as the outer shape of the gingiva former. The term further covers the creation of slightly different forms for any particular reason. For example when designing the restoration some restrictions, such as minimum material thicknesses or similar, have to be considered which might make it necessary to deviate from an identical form. However, such adapted forms of the emergence profile of the restoration are still created in correspondence with the outer shape of the gingiva former.

Thereby, the creation of the restoration can be achieved in a fully or partially automatic or digital procedure as well as in a manual or analogue procedure. Thus, the overall method according to the invention may be a purely manual or analogue method, a purely automatic, computer implemented or digital method or any combination thereof. In a preferred embodiment, the method is fully digital, relying on accurate intra-oral scanning technology, such that no additional, costly and complicated accessories for impression taking and similar steps are needed.

By obtaining the outer shape of the gingiva former and position of the same gingiva former when mounted to the implant structure, it is ensured that all data or information are taken into account which are relevant to designing a functional restoration. It can be prevented that unaesthetic and inflammation-prone soft tissue shrinkage gaps are created in the gumline after the final restoration is secured to the implant structure. Thanks to the method above described, by designing the final restoration based on the mentioned combination, the final restoration will advantageously possess the same emergence profile previously established by the provisional application of a best-fitting gingiva former.

Moreover, a CAD design of the dental restoration can begin at a very early stage, thus saving time. It is in fact not necessary to remove the gingiva former to scan directly the implant or its scan body, respectively, which is normally the procedure followed in the state of the art.

Also, avoiding a premature removal of the gingiva former prevents any risk of injuries in the recently cut and not yet fully conditioned soft tissue and/or any early stress on the implant which needs to progressively osteointegrate after insertion. Thus, the gingiva former can be first removed just when the restoration is ready to be placed.

In this connection, the method according to the invention allows for impressing directly after the implant structure is set and the gingiva former is mounted to the implant structure. This may reduce the number of patient sessions and, therefore, ease the process. In particular, a separate session of removing the gingiva former after healing of the jaw resulting in integration of the implant structure, and separately impressing may be prevented.

The method of producing a dental restoration according to the present invention enhances the predictability of a good fit of the restoration in the socket and ideally integrates in the restoration a custom-shaped emergence profile which best approximates a natural gumline.

In the method according to the present invention, the step of obtaining the outer shape of the gingiva former preferably comprises obtaining gingiva former data including data about the outer shape of the gingiva former.

Particularly, such gingiva former data, including data about the outer shape of the gingiva former, can be obtained from libraries containing a number of gingiva former types, sub-types and subsequent approximations to any possible emergence profile configuration. Such libraries may be filled with anatomy-derived templates, which an operator can select to best fit a cavity of gingival tissue formed as a result of a missing tooth and possibly further modify to adjust to the given patient-specific clinical situation. The libraries could, for instance, contain a multiplicity of templates for any typology of tooth restoration needed. That is, a multiplicity of gingiva former templates could be provided for each category of tooth, as in for incisors, canines, pre-molars and molars etc. For this purpose, the method according to the present invention can comprise storing gingiva former data about a plurality of different gingiva formers and providing the plurality of gingiva formers in a digital library.

Accordingly, the computer assisted modelling of the dental restoration can be based also on the gingiva former data, automatically incorporating the information relating to the geometry of the gingiva former and especially its emergence profile into the design of the restoration.

An advantageous correlation of the position of the gingiva former from an intra-oral scanning operation with data derived from a gingiva former library as above described can achieve an optimal compliance of an ideal emergence profile with the actual situation in the given oral cavity.

The correlated data can be advantageously merged with further data input and/or elaborated via a computer-aided design software, also of the chair-side type, for computation of the restoration.

Preferably, creating the restoration according to the method of the present invention comprises providing restoration design data appropriate to be loaded to an automatic restoration manufacturing apparatus. Creating the restoration preferably further comprises providing a graphical representation of the restoration, which can be sent to the automatic restoration manufacturing apparatus.

The automatic restoration manufacturing apparatus is then instructed to produce the physical restoration. Thus the fully digital work-flow is maintained with the sending of restoration design data to a CAM machine of an integrated computer aided design and computer aided manufactory (CAD/CAM) system.

The automatic restoration manufacturing apparatus may comprise a dental milling machine or a 3D-printer.

A suitable milling machine can be an in-office milling machine which allows a dental professional to obtain the restoration in loco soon after designing it. Or it can be a bigger model delocalized in a milling center. Such milling machines, based on the designed 3D digital model, can carve a dental restoration from a solid block of ceramic, resin or other material.

Alternatively, a 3D printer, or more in general an additive manufacturing apparatus, can be fed with the elaborated virtual model of the dental restoration, for producing the physical dental restoration.

Particularly in the case of screw-retained dental restoration which are secured via a screw to the underlying implant, or to an intermediate abutment engaged with the implant, the prosthetic restoration is preferably designed with a channel extending through the restoration. The channel can particularly extend from an occlusal end (also designatable as coronal end) to an apical end of the restoration. Alternatively, the method according to the present invention can be carried out to produce a cement-retained dental restoration.

Preferably, determining the orientation of the gingiva former comprises determining a trajectory, or an axis, and rotational position of the gingiva former relative to the jaw.

Preferably, creating the restoration with the emergence profile comprises designing the outer shape of the emergence profile with a smooth geometry. The term “smooth geometry” in this context can relate to forms that do not comprise any angled sections or the like. Such a smooth geometry allows for a well tolerated integration of the restoration in the mouth of the patient allowing a sophisticated adaptation of the gingiva to the emergence profile. The smooth geometry can also be advantageous in that it can drastically reduce the risk of the build-up of bacteria or other infection sites and ensuing infection pockets.

Thereby, the smooth geometry of the emergence profile preferably has at least one non-straight section. The smooth geometry of the emergence profile preferably has at least one rounded section. Such non-straight or rounded section allows for an efficient embodying of a smooth geometry. Thereby, the at least one rounded section preferably has a radius larger than 0.3 millimeter (mm) or larger than 0.5 mm. Such radii allow for a convenient adaptation of the gingiva during integration of the restoration.

The smooth geometry of the emergence profile preferably consists of at least one straight section and the at least one rounded section, or of the at least one rounded section only. By only having straight and rounded sections, the geometry of the emergence profile allows for preventing or minimizing adherence or generation of any inflammatory site at the emergence profile. Like this, acceptance and longevity of the restoration can essentially be increased. The smooth geometry of the emergence profile further preferably excludes an undercut or indentation. As undercuts or indentations often have the potential of holding residues, such as bacteria or the like, they can be causal for the generation of inflammatory sites or similar harms. By preventing such undercuts, the risk of inflammations can be reduced.

In an advantageous embodiment, the outer shape of the gingiva former does have a smooth geometry. In particular, this smooth geometry can be embodied with the same features as the smooth geometry of the emergence profile of the dental restoration. In particular, the smooth geometries can be essentially identical or corresponding to each other.

As described above, obtaining the outer shape of the gingiva former may comprise a step of creating an analogue impression of the gingiva former. With such analogue impression conventional techniques can be used for determining the outer shape of the gingiva former. Even though such process may be more time consuming than corresponding digital methods they may be particularly precise and reliable. Also, since such conventional techniques are widespread, they may have a high acceptance.

Alternatively or additionally, obtaining a position of the gingiva former mounted to the implant structure preferably comprises obtaining scan data of the gingiva former. Such scan data may be obtained by scanning the gingiva former when being set on the implant and transferring the respective data to be further processed. This allows for a completely digital implementation of the method which may be more efficient and accurate.

Preferably, obtaining the position of the gingiva former mounted to the implant structure comprises evaluating an index of the implant structure. Using such an index allows for very efficiently determining the position in a sufficiently accurate manner.

Alternatively or additionally, obtaining the position of the gingiva former mounted to the implant structure preferably comprises creating an analogue impression of the implant structure and the jaw in a region around the implant structure. Creating such an impression allows for accurately determining the position by using widespread and accepted techniques.

Preferably, the method according to the invention is a computer implemented method. Like this, the method can efficiently be implemented and its effects and benefits achieved.

In another aspect, the invention is a method of restoring a tooth with a dental restoration, i.e. a dental restoring method, comprising:
fixing an implant structure to a jaw of a patient;
choosing a gingiva former with an outer shape suiting to a gingiva channel extending from an oral cavity of the patient to the fixed implant structure;
placing the gingiva former on the fixed implant structure;
scanning the gingiva former or scan body;
determining the orientation of the gingiva former relative to the jaw based on information obtained by scanning the gingiva former or scan body;
producing the restoration with an emergence profile formed in correspondence with the outer shape of the gingiva former and the determined orientation thereof;
removing the gingiva former from the fixed implant structure; and
mounting the restoration on the fixed implant structure.

Preferably, scanning the gingiva former comprises mounting a scan body with landmarks on the gingiva former and scanning the landmarks of the scan body when being mounted on the gingiva former—while the gingiva former is, in its turn, mounted to the underlying implant structure.

Additionally or particularly alternatively, if it is desired to prevent the use of a further accessory such as a scan body, the gingiva former itself may be equipped with landmarks accessible from the oral cavity of the patient. In this case, scanning the gingiva former can comprise scanning the landmarks of the gingiva former.

Determining the orientation of the gingiva former relative to the jaw therefore preferably implies deriving, by intra-oral scanning either a scan body as above described or directly the gingiva former itself, information such as at least the angular position of the gingiva former in relation to the socket and the overall oral cavity; or a trajectory, or an axis, of the gingiva former.

Based on the pre-defined characteristics of the gingiva former selected from a library or a database as above described, and in combination with the above data derived from intra-oral scanning, the overall orientation of the gingiva former in relation to the soft tissue of the surrounding gingiva and/or in relation to the teeth neighboring the implant site and/or in relation to the antagonist teeth can be computed.

The scannable landmarks on the scannable element—i.e. on the scan body and/or on the gingiva former—can comprise a flat or inclined side surface whose orientation can be of aid to infer the angular orientation of the overall scanned element; plateaus offset along the axis of the scannable element, in order to infer height, or distance, information between respective planes on which the plateaus lie; or longitudinal planes which can provide an additional indication on an axis of the scannable element.

Knowing that the gingiva former and/or the scan body are affixed to the underlying component in a definite, indexed position—e.g., thanks to anti-rotational locking features of the connection therebetween—also the overall spatial orientation of the inserted implant can be reversely computed. This may include: i) the angular position of the implant; ii) the axis of the implant and iii) its height with respect to soft tissue, to adjacent teeth and/or to the occlusal surfaces of the antagonist teeth.

As already mentioned, choosing the gingiva former preferably comprises providing a set of gingiva formers having different outer shapes and selecting the gingiva former of the set of gingiva formers suiting to the gingiva channel. The set of gingiva formers, filled in an appropriate library, can therefore function as templates for the creation of the dental restoration

Preferably, in case the gingiva former has an axial bore, placing the gingiva former on the fixed implant structure according to the present method of restoring a tooth comprises forwarding a screw through the bore of the gingiva former into the implant structure.

Preferably, the scan body and/or the gingiva former are at least partly made of scannable material, such as polyether ether ketone (PEEK), titanium having a specific coating or the like.

Preferably, the outer shape of the gingiva former has a smooth geometry. Such smooth geometry of the gingiva former can be embodied as follows: Preferably, the smooth geometry of the gingiva former has at least one non-straight section. Preferably, the smooth geometry of the gingiva former has at least one rounded section. Thereby, the at least one rounded section preferably has a radius larger than 0.3 mm or larger than 0.5 mm. Preferably, the smooth geometry of the gingiva former consists of at least one straight section and the at least one rounded section, or of the at least one rounded section only. Preferably, the smooth geometry of the gingiva former excludes an undercut.

The outer shape of the emergence profile of the dental restoration preferably is generated with a smooth geometry corresponding to the smooth geometry of the outer shape of the gingiva former, or being identical. Such smooth geometry of the outer shape of the gingiva formed and/or of the emergence profile of the dental restoration allow for achieving the effects described above.

The method of producing a dental restoration, i.e. the production method, and the method of restoring a tooth with a dental restoration, i.e. the restoring method, typically are methods not suitable for treatment of the human or animal body by surgery or therapy and diagnosis practised on the human or animal body. In particular, they can be ex vivo methods.

In a further other aspect, the invention is a dental restoration comprising an occlusal end, an apical end opposite to the occlusal or coronal end, an emergence profile extending from the apical end towards the occlusal end, and a channel extending from the apical end to the occlusal end. The channel can particularly be an axial bore, for passage of a fixation screw securing the restoration directly to the implant structure supporting the restoration.

Preferably, the apical end of the dental restoration is equipped with a mating formation suiting to a corresponding formation of the implant structure, such that the dental restoration is positionable in at least one distinct orientation on the implant structure, when the mating formation of the end side and the corresponding formation of the implant structure interact. The at least one distinct orientation can be a plural indexed orientation. For instance, the mating formation can comprise a hex or an octagon.

Preferably, the emergence profile of the dental restoration has an outer shape suiting to a gingiva channel extending from an oral cavity of a patient to an implant structure fixed to a jaw of the patient or to an abutment structure mounted to such an implant structure.

In a preferred embodiment, the outer shape of the emergence profile has a smooth geometry, as above described. In particular, the smooth geometry of the emergence profile preferably has at least one non-straight section. The smooth geometry of the emergence profile preferably has at least one rounded section. Thereby, the at least one rounded section preferably has a radius larger than 0.3 mm or larger than 0.5 mm. The smooth geometry of the emergence profile preferably consists of at least one straight section and the at least one rounded section, or of the at least one rounded section only. The smooth geometry of the emergence profile preferably excludes an undercut. By such smooth geometry of the emergence profile and its preferred embodiments the effects and advantages described above in connection with the method according to the invention can be achieved.

The dental restoration according to the preset invention is preferably designed and manufactured following a work-flow which corresponds to the above described method of producing a dental restoration.

In still another further aspect, the invention is a computer program comprising computer readable commands causing a computing device to implement the method as above described, when being loaded to and/or executed by the computing device. Such computer program can be included or connected to a dental design system such as a CAD/CAM system or the like.

### BRIEF DESCRIPTION OF THE DRAWINGS

A dental restoration according to the invention produced by the computer implemented method according to the invention, as well as steps of the methods according to the invention are described in more detail hereinbelow by way of an exemplary embodiment and with reference to the attached drawings, in which:

FIG. 1 shows a first gingiva former embodied according to the present invention to have an outer shape suiting a gingiva channel, wherein the gingiva former has been placed on an implant structure which is fixed to the jaw of a patient, in particular displaying a scan body with landmarks mounted on the gingiva former, the gingiva former being secured to the implant structure by way of a screw;

FIG. 2 shows a second gingiva former according to the present invention, also provided with a scan body analogously to the case of FIG. 1, wherein an outer shape of the gingiva former is shown in relation to a gingiva channel of a soft tissue structure of the jaw of a patient;

FIG. 3 shows a dental restoration according to the present invention, comprising an emergence profile extending from an apical end towards an occlusal end which complies with the shape of a gingiva channel imparted by a specifically selected gingiva former, analogous to the gingiva formers shown in FIG. 1 or 2;

FIG. 4 shows a lateral view of a graphical representation of a dental restoration, created by way of a CAD computer executable program adapted to implement the method of producing a dental restoration according to the present invention, highlighting an emergence profile which is formed in correspondence with the outer shape of a best-fitting gingiva former selected from a library;

FIG. 5 shows a top view of the graphical representation of the dental restoration of FIG. 4, wherein the emergence profile is further appreciable in a section cut, overlay view and, additionally, an orientation of the dental restoration is marked with respect to the jaw of a patient; and

FIG. 6 shows a view from top of a graphical representation of a dental restoration according to the present invention, as visible from a lingual side, wherein the dental restoration takes the form of screw-retained bridge.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

Technical terms such as apical as opposed to occlusal or coronal, and lingual as opposed to buccal are used as commonly known in the art of dentistry.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

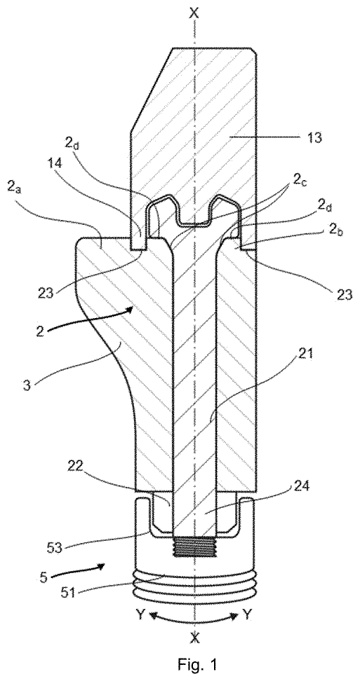

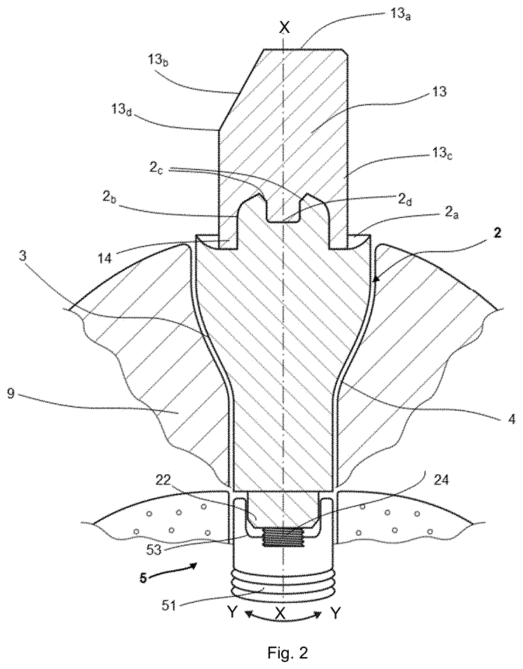

With reference to FIGS. 1 and 2, a first embodiment and a second embodiment of gingiva formers 2 are shown which, according to the present invention, can be selected by an operator on a dedicated dental CAD software from anatomy-specific libraries to have an outer shape 3 suiting a gingiva channel 4 in correspondence of a missing tooth to be replaced by a crown as a restoration 1. Data of the outer shape 3 of the gingiva former can therefore be obtained once the best-fitting gingiva former 2 is selected, for instance following input from an operator or in a completely automated way. In both FIGS. 1 and 2, it is shown that the gingiva former 2 is placed on an implant 51 as implant structure 5 which is fixed to a jaw of a patient and that a scan body 13 with landmarks is mounted on the gingiva former 2. In FIG. 1, the gingiva former 2 is section cut to fully show a screw 24 for fixation to the implant structure 5. In FIG. 2, only an apical end of the screw 24 engaging with a matching thread in the implant structure 5 is shown.

As mentioned above, the gingiva former 2 and the scan body 13 are affixed to the underlying component, respectively the implant structure 5 and the gingiva former 2 itself, in a definite, indexed position thanks to anti-rotational locking features as mating structure of the connection therebetween.

In FIGS. 1 and 2, these anti-rotational, locking features take the form of notches 23 into which corresponding protrusions 14 of the scan body 13 engage so that the scan body 13 is supported in a known, definite, indexed position relative to the underlying gingiva former 2. On the other hand, the implant 51 is provided with own anti-rotational, locking features 53, for instance in the form of hex-shaped or an octagon shaped notches, which are designed to match corresponding protrusions 22 of the gingiva former 2, so that the gingiva former 2 is supported in a known, definite, indexed position relative to the underlying implant 51.

The above described system of double-indexing ensures that, ultimately, the scan body 13 is in a known spatial relationship with the respect to the underlying inserted implant 51, via the gingiva former 2 which is held in a fixed relationship with both the scan body 13 and the implant 51. This guarantees that the positions of the implant 51 and of the gingiva former 2 are registered in a way that an ensuing restoration, designed based on the available position information, is correctly oriented in the jaw 7 of a patient, taking into due account adjacent teeth, antagonist teeth and/or soft tissue.

In order to reversely compute the overall spatial orientation of the gingiva former 2 or, equivalently, given the above described configuration, of the inserted implant 51, the scan body 13 can be provided with landmarks 13a, 13b, 13c, which, illuminated during the scanning operation, can provide information for the automatic calculation of a multiplicity of relevant geometrical characteristics. The landmarks can take the shape of an inclined side surface 13b, a plateau 13a, and lateral surfaces 13c. Based on the scanning of these landmarks, possibly in correlation with the scanning of further landmarks on the gingiva former 2, for instance, information about a trajectory, or axis, X-X, as well as a rotational position Y-Y relative to the jaw 7 can be derived. Knowing the measure of the components selectively employed, that is of the scan body 13 and the gingiva former 2, and deriving the height of the plateau 13a over the gingiva former base surface 2a, for instance, the height of the gingiva former 2 within the jaw 7 is known - with respect to soft tissue, to adjacent teeth and to the occlusal surfaces of the antagonist teeth. The insertion depth of the implant structure 5 can be also consequently derived. The scanning of lateral surfaces 13c can be of aid for tracing the trajectory, or axis, X-X of the gingiva former 2 and, accordingly, of the underlying implant 51.

The gingiva former 2 itself can be equipped with scannable landmarks 2a, 2b, 2c, 2d accessible from the oral cavity of the patient, either when a scan body 13 is mounted on top or when the scan body 13 has been removed. Therefore, the gingiva former 2 can itself function as a scan body, either in cooperation with a further dedicated scan body 13 or on its own. Any specifically configured surface of the gingiva former 2 can function as landmark, as represented in FIGS. 1 and 2. Therefore the landmarks can take the form of aptly designed cusps, plateaus, inclined surfaces, notches etc.

Once the overall orientation of the gingiva former 2 relative to the jaw 7 is known, a restoration can be designed which has both an emergence profile 8 formed in correspondence with the outer shape of the gingiva former 3 as well as the orientation of the gingiva former 2 as above determined by way of scanning. Advantageously, the restoration 1 can be shaped optimally to comply with the gingiva channel 4 and to be correctly positioned in the context of the overall dental arch, for optimal aesthetical and functional results.

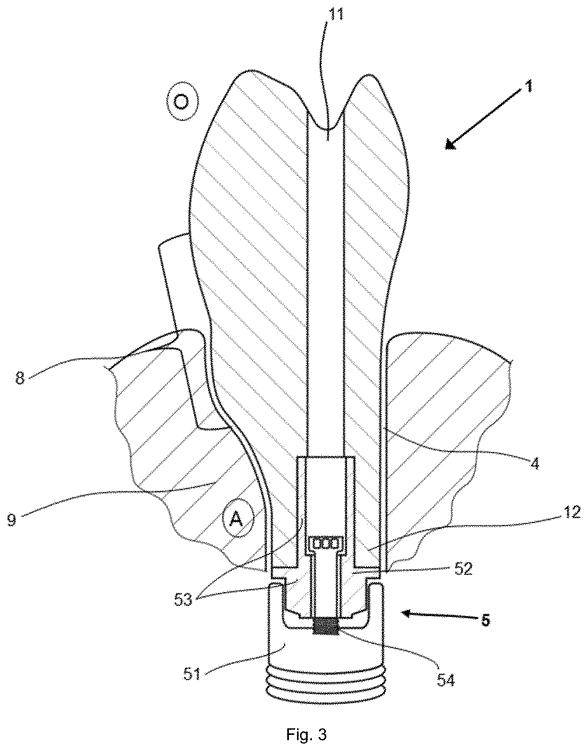

In FIG. 3, a specific embodiment of a dental restoration 1 according to the present invention is shown. The restoration 1 is created with a channel 11 extending therethrough, from an occlusal end O to an apical end A thereof. The restoration 1 incorporates an emergence profile 8, at least partially surrounded by the soft tissue structure 9, or gingiva, which is formed in correspondence to the outer shape 3 of the previously selected gingiva former 2. The restoration 1 designed in conformity with the present invention possesses substantially the same emergence profile 8 as the emergence profile created by the selected gingiva former 2 during its temporary placement onto the implant structure 5 for the conditioning of the soft tissue 9 surrounding the gingiva channel 4.

The apical end A of the dental restoration 1 is equipped with a mating formation 12 suiting to a corresponding formation 53 of the implant structure 5, such that the dental restoration 1 is positionable in at least one distinct orientation on the implant structure 5 when the mating formation 12 of the apical end A and the corresponding formation 53 of the implant structure 5 interact, inter-engaging. As already mentioned, the at least one distinct orientation can be a plural indexed orientation, for instance if the formation 53 of the implant structure 5 is a hex or an octagon.

The formation of the implant structure 5 corresponding to the mating formation 12 can take the form of the above-mentioned anti-rotational, locking features 53 directly incorporated by the implant 51 or, as shown in FIG. 3, such formation can take the form of connection features incorporated by an intermediate base abutment 52, providing support to the restoration 1 and affixed to the implant 51.

In FIG. 3, the base abutment 52, and, as a consequence, the restoration 1 are secured to the implant 51 by way of a basal screw 54.

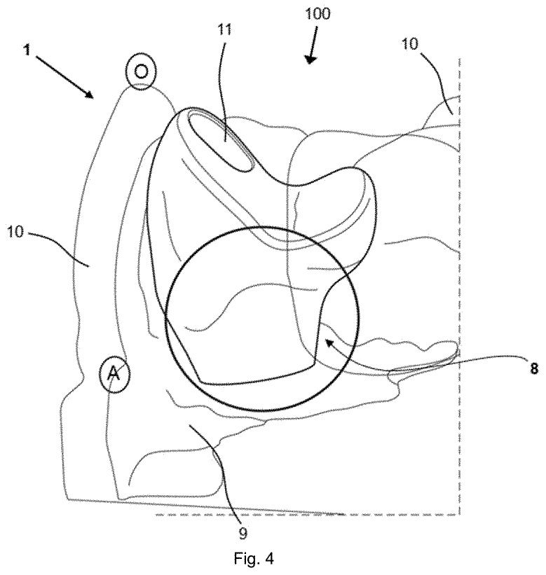

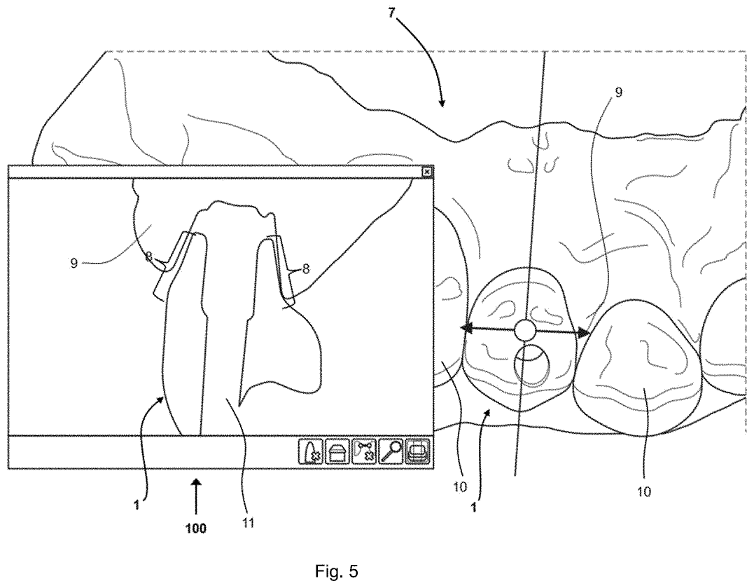

FIGS. 4 and 5 show graphical representations 100 of a restoration 1 produced according to the computer implemented method of the present invention. In particular, it can be appreciated how the designed emergence profile 8 has a smooth geometry which does not comprise sharply angled sections and has non-straight sections. In particular, the non-straight sections are rounded sections having radii larger than 0.5 mm. Particularly the overlay, section-cut view of FIG. 5 shows how the emergence profile 8 of the restoration 1 ideally follows the soft tissue structure 9 where emerging from the gingiva channel 4. The outer geometry does excludes any undercut. Additionally, in FIG. 5 an orientation of the dental restoration 1 is marked with respect to the jaw 7 of a patient.

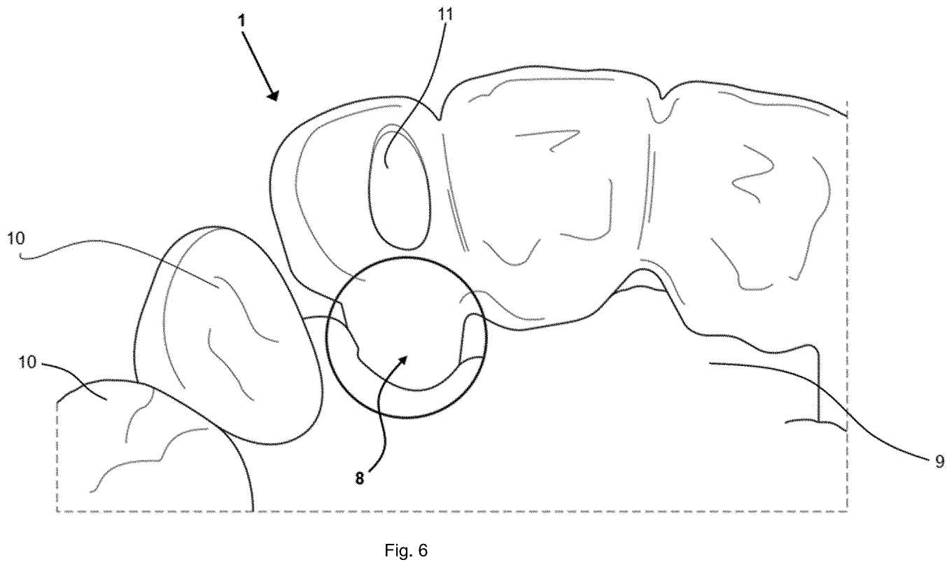

FIG. 6 shows a view from top of a graphical representation 100 of a dental restoration 1 according to the present invention, seen from a lingual side. In this specific case, the dental restoration 1 takes the form of screw-retained bridge.

This description and the accompanying drawings that illustrate aspects and embodiments of the present invention should not be taken as limiting the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

For example, it is possible to operate the invention in embodiments in which:
the restoration and particularly its emergence profile is analogously designed and analogously created or manufactured;
the restoration and particularly its emergence profile is analogously designed and digitally created or manufactured;
the restoration and particularly its emergence profile is digitally designed and analogously created or manufactured; and
the restoration and particularly its emergence profile is digitally designed and digitally created or manufactured.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

A computer program may be stored/distributed on a suitable medium, such as an optical storage medium or a solid-state medium supplied together with or as part of other hardware, but may also be distributed in other forms, such as via the Internet or other wired or wireless telecommunication systems. In particular, e.g., a computer program can be a computer program product stored on a computer readable medium which computer program product can have computer executable program code adapted to be executed to implement a specific method such as the method according to the invention. Furthermore, a computer program can also be a data structure product or a signal for embodying a specific method such as the method according to the invention.

1-41. (canceled)

42. A computer implemented method of producing a dental restoration comprising:
obtaining an outer shape of a gingiva former suiting to a gingiva channel extending from an oral cavity of a patient to an implant structure fixed to a jaw of the patient;
obtaining a position of the gingiva former mounted to the implant structure;
determining the orientation of the gingiva former relative to the jaw based on the obtained position; and
creating the restoration with an emergence profile formed in correspondence to the obtained outer shape of the gingiva former and the determined orientation of the gingiva former,
wherein creating the restoration comprises designing the outer shape of the emergence profile with a smooth geometry having at least one rounded section.

43. The method of claim 42, wherein the smooth geometry of the emergence profile
has at least one non-straight section, and/or
consists of at least one straight section and the at least one rounded section, or of the at least one rounded section only, and/or
excludes an undercut.

44. The method of claim 42, wherein the at least one rounded section has a radius larger than 0.3 millimeter or larger than 0.5 millimeter.

45. The method of claim 42, wherein creating the restoration comprises providing restoration design data appropriate to be loaded to an automatic restoration manufacturing apparatus, wherein the automatic restoration manufacturing apparatus preferably comprises a dental milling machine or a 3D-printer.

46. The method of claim 42, wherein creating the restoration comprises providing a graphical representation of the restoration.

47. The method according of claim 42, wherein the restoration is created with a channel extending through the restoration.

48. The method of claim 42, wherein determining the orientation of the gingiva former comprises determining a trajectory and a rotational position relative to the jaw.

49. The method of claim 42, wherein obtaining the outer shape of the gingiva former comprises obtaining gingiva former data including data about the outer shape of the gingiva former.

50. The method of claim 42, comprising storing gingiva former data about a plurality of different gingiva formers and providing the gingiva former data about the plurality of gingiva formers in a digital library.

51. The method of claim 42, wherein obtaining the outer shape of the gingiva former comprises creating an analogue impression of the gingiva former.

52. The method of claim 42, wherein obtaining the position of the gingiva former mounted to the implant structure comprises obtaining scan data of the gingiva former.

53. The method of claim 42, wherein obtaining the position of the gingiva former mounted to the implant structure comprises evaluating an index of the implant structure.

54. The method of claim 42, wherein obtaining the position of the gingiva former mounted to the implant structure comprises creating an analogue impression of the implant structure and the jaw in a region around the implant structure.

55. A dental restoration produced by the method according to claim 1 comprising:
an occlusal end;
an apical end opposite to the occlusal end;
an emergence profile extending from the apical end towards the occlusal end; and
a channel extending from the apical end to the occlusal end,
wherein the emergence profile has an outer shape suiting to a gingiva channel extending from an oral cavity of a patient to an implant structure fixed to a jaw of the patient,
wherein the outer shape of the emergence profile has a smooth geometry, and
wherein the smooth geometry of the emergence profile has at least one rounded section.

56. The dental restoration of claim 55, wherein the apical end is equipped with a mating formation suiting to a corresponding formation of the implant structure such that the dental restoration is positionable in at least one distinct orientation on the implant structure when the mating formation of the apical end and the corresponding formation of the implant structure interact.

57. The dental restoration of claim 55, wherein the smooth geometry of the emergence profile
has at least one non-straight section, and/or
consists of at least one straight section and the at least one rounded section, or of the at least one rounded section only, and/or
excludes an undercut.

58. The dental restoration of claim 55, wherein the at least one rounded section has a radius larger than 0.3 millimeter or larger than 0.5 millimeter.

59. A method of restoring a tooth with a dental restoration comprising:
fixing an implant structure to a jaw of a patient;
choosing a gingiva former with an outer shape suiting to a gingiva channel extending from an oral cavity of the patient to the fixed implant structure;
placing the gingiva former on the fixed implant structure;
scanning the gingiva former;
determining the orientation of the gingiva former relative to the jaw based on information about the scanned gingiva former;
producing the restoration with an emergence profile formed in correspondence with the outer shape of the chosen gingiva former and with the determined orientation of the gingiva former;
removing the gingiva former from the fixed implant structure; and
mounting the restoration on the fixed implant structure,
wherein the outer shape of the gingiva former has a smooth geometry, and
wherein the smooth geometry of the gingiva former has at least one rounded section.

60. The method of claim 59, wherein scanning the gingiva former comprises mounting a scan body with landmarks on the gingiva former and scanning the landmarks of the scan body when being mounted on the gingiva former.

61. The method of claim 59, wherein the gingiva former is equipped with landmarks accessible from the oral cavity of the patient and scanning the gingiva former comprises scanning the landmarks of the gingiva former.

62. The method of claim 59, wherein choosing the gingiva former comprises providing a set of gingiva formers having different outer shapes and selecting the gingiva former of the set of gingiva formers suiting to the gingiva channel.

63. The method of claim 59, wherein the gingiva former has an axial bore and placing the gingiva former on the fixed implant structure comprises forwarding a screw through the axial bore of the gingiva former into the implant structure.

64. The method of claim 59, wherein the smooth geometry of the gingiva former has at least one non-straight section, and/or excludes an undercut.

65. The method of claim 59, wherein the at least one rounded section has a radius larger than 0.3 millimeter or larger than 0.5 millimeter and/or wherein the smooth geometry of the gingiva former consists of at least one straight section and the at least one rounded section, or of the at least one rounded section only.
